(19) United States
(12) Patent Application Publication
(10) Pub. No.: US 2022/0048425 A1
(43) Pub. Date: Feb. 17, 2022

(54) TIE DOWN DEVICE

(71) Applicant: Abelino Carrillo Catalan, San Rafael, CA (US)

(72) Inventor: Abelino Carrillo Catalan, San Rafael, CA (US)

(21) Appl. No.: 16/995,116

(22) Filed: Aug. 17, 2020

(51) Int. Cl. B60P 7/08

(52) U.S. Cl. CPC B60P 7/0823

(57) ABSTRACT

A tie down device which includes a hub having a peripheral edge and plurality of stretch cord receiving slots. A plurality of stretch cords are provided, each of the stretch cords being sized to pass within and be retained by a pair of receiving slots such that each stretch cord has terminal ends that extend on a first side of the hub and a looped body portion extending on a second side of the hub.

### TECHNICAL FIELD OF THE INVENTION

The present invention involves a tie downs device of the type usually associated with bungee cords. Typically, bungee cords are stretchable having hooks at their terminal ends which are used for a variety of situations such as retaining materials within the bed of a pickup truck or similar vehicle. When not in use, bungee cords are difficult to store, get entangled and are oftentimes lost. The present invention deals with these issues as well as others in providing a unique and improved tie down system.

### BACKGROUND OF THE INVENTION

Bungee cords are used in a variety of situations, so many so that any attempt to limit their application would be an exercise in futility. Most commonly, those that own open bed pickup trucks will fill their beds with debris, apply a tarp to the debris and hold the tarp down by bungee cords to prevent inadvertent loss. As bungee cords are fixed in length and are stored and used as individual standalone articles, it is difficult to store them as they get tangled and oftentimes lost. As each bungee cord is of a fixed length terminated with hooks, users find themselves needing a number of cords to handle a variety of tie down distances. For example, in referring back to securing the contents of an open bed pickup truck, if the load is relatively small so that the bungee cords can extend linearly between tie down hooks of the bed, shorter bungee cords would be required than if the load was larger such that the bungee cords had to traverse a mound between the sidewalls of the open bed.

Because users of bungee cords generally acquire and retain a significant plurality of them in order to handle anticipated multiple uses, when not in use, the cords tend to not only become lost but also entangled.

It is thus an object of the present invention to provide a tie down device which addresses the limitations and shortcomings of bungee cords currently available.

It is still a further object of the present invention to provide a tie down device which is capable of extending between connecting points of differing length without the need to revert to an inventory of multiple cords.

It is yet a further object of the present invention to provide a tie down device which maintains a plurality of stretch cords without entanglement creating a more secure and user-friendly way of storing stretch and bungee cords when not in use.

These and further objects will be more readily apparent when considering the following disclosure and appended claims.

### SUMMARY OF THE INVENTION

A tie down device comprising:

a hub, said hub having a peripheral edge and plurality of stretch cord receiving slots; and

a plurality of stretch cords, each of said stretch cords being sized to pass within and be retained by a pair of receiving slots such that each stretch cord has terminal ends that extend on a first side of said hub and a looped body portion extending on a second side of said hub.

A tie down device comprising:

a hub, said hub having a peripheral edge and a plurality of stretch cord receiving openings; and

a plurality of stretch cords, said stretch cords being terminated with hooks, said hooks being sized to pass within and be removably retained within said stretch cord receiving openings.

### BRIEF DESCRIPTION OF THE DRAWINGS

FIG. 1 is a plan view of the hub constituting a portion of the present tie down device.

FIG. 2 is a perspective view of a first embodiment the tie down device of the present invention employing the hub of FIG. 1.

FIG. 3 is a perspective view of the tie down device of FIG. 2 as typically employed on the open bed of a pickup truck.

FIG. 4 is a cross-sectional view of a clip applied to a stretch cord in order to adjust the length of the stretch cord between its terminal ends.

FIG. 5 is the tie down device of the present invention employing the clips of FIG. 4.

FIG. 6 is a perspective view of a second embodiment of the present invention.

FIG. 7 is a perspective view of third embodiment of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

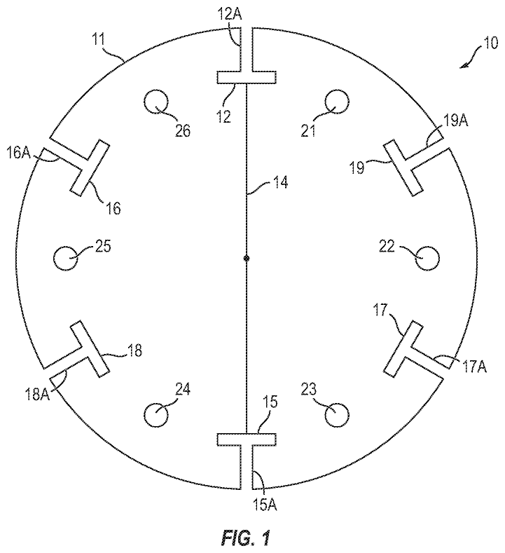

In turning to FIG. 1, hub 10 is depicted having peripheral edge 11 and a series are receiving slots 12, 19, 17, 15 and 16. Any number of such receiving slots can be employed in practicing the present invention further noting that hub 10 composed of a rigid material such as metal or plastic is chosen to resist breakage when it is employed for its intended purpose. Hub 10 is shown to be circular which is its preferred geometry although other geometric shapes can be employed without deviating from the spirit and scope of the present invention.

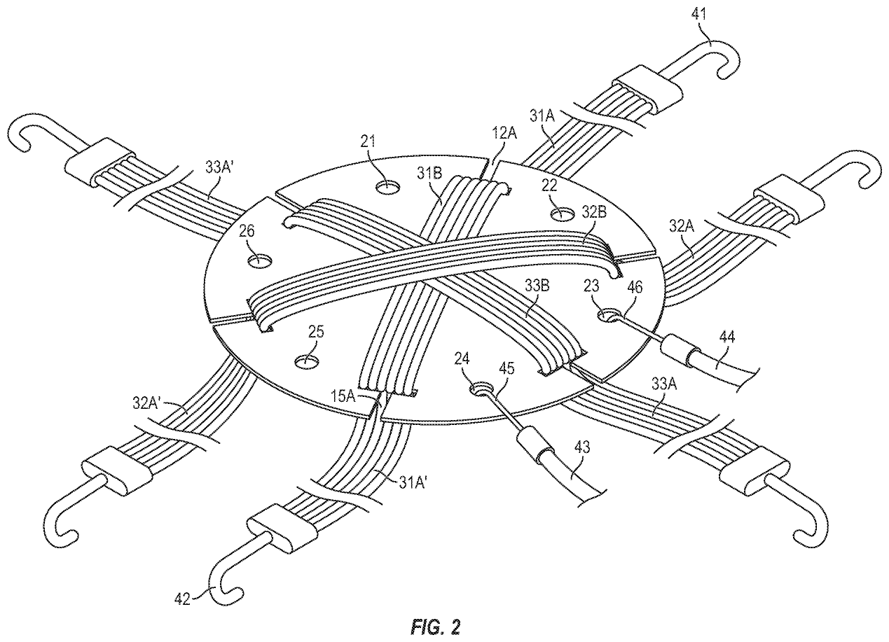

A plurality of stretch cords are applied to hub 10 as best seen in reference to FIG. 2. Each stretch cord is inserted through a pair of receiving slots diametrically opposed to one another. For example, a stretch cord having segment 31A beneath hub 10 passes through slot 12 providing for segment 31B above hub 10 which then serpentines through slot 15 terminating beneath hub 10 as segment 31A′, slots 12 and 15 being diametrically opposed to one another along diameter 14 (FIG. 1). Similarly, stretch cord having segment 32A beneath hub 10 passes through slot 19 providing for segment 32B above hub 10 which then enters slot 18 providing for segment 32A′ terminating beneath hub 10. Finally, in reference to FIG. 2, a third stretch cord is shown inserted through a pair of receiving slots 17 and 16 diametrically opposed to one another creating segment 33A beneath hub 10 passing through slot 17 providing for segment 33B above hub 10 which then passes through slot 16 providing for segment 33A′ terminating beneath hub 10. Each of these stretch cords can be introduced and removed from hub 10 by virtue of their respective passageways such as passageway 12A and 15A as shown.

As each of these stretch cords is intended to act as a tie down component, the stretch cords generally are terminated by hooks, examples of which are identified as hooks 41 and 42. Hub 10 can also be provided, as a preferred embodiment, with bungee cord receiving openings 21, 22, 23, 24, 25 and 26 to enable standard bungee cords 43 and 44 to attach to hub 10 by virtue of hook members 45 and 46.

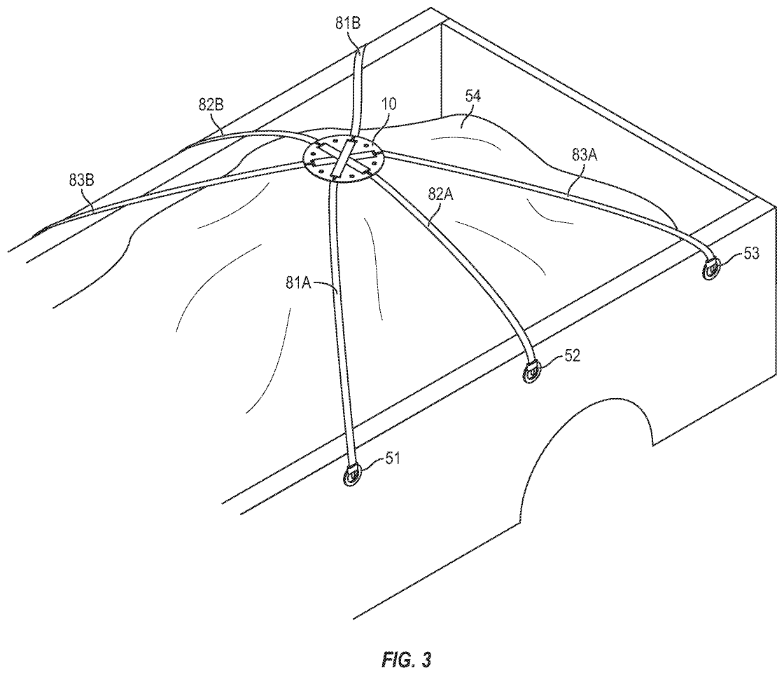

As noted in reference to FIG. 3, a typical non-limiting use for the present invention is to tie down and secure the contents of an open flatbed truck. In this instance, tarp 54 can be placed over the contents of the flatbed area while various stretch cords 81A/81B, 82A/82B and 83A/83B are attached to tie downs 51, 52 and 53 (with corresponding tie downs on the opposite side of the vehicle bed-not shown). As noted, suitable bungee cords could also be appended to hub 10 as discussed in reference to FIG. 2 as needed.

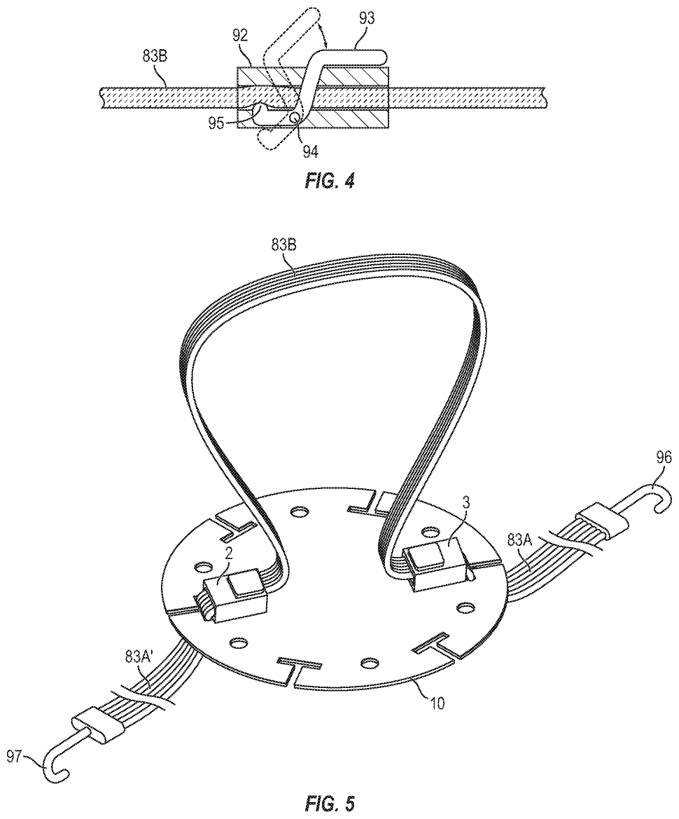

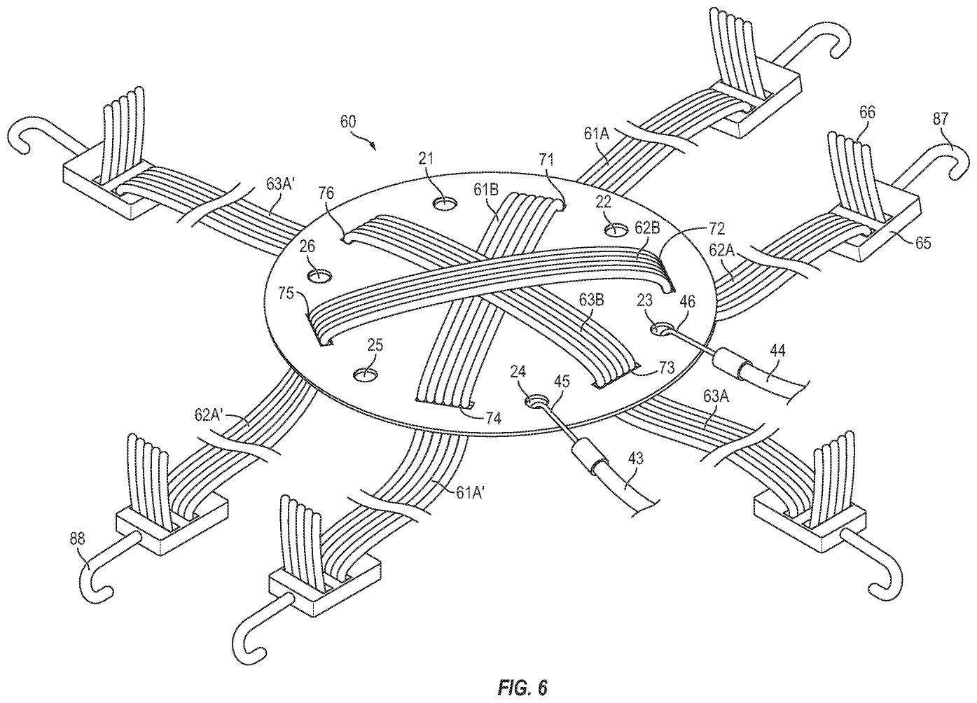

As a further preferred embodiment, reference is made to FIGS. 4 and 5. Unlike pre-existing bungee cords which are generally available only in standard lengths (requiring the inventory of a plurality of such cords), the present invention provides for the ability to adjust the distance between stretch cord terminal hooks 96 and 97. This is accomplished by securing clips 2 and 3 upon segment 83B which serpentines above hub 10 as shown. Although any suitable clip pair can be employed which are capable of slidably moving along a suitable stretch cord, an example of a clip which can be used herein is shown in FIG. 4. In this instance, clips 2 and 3 are shown surrounding stretch cords segment 83B having lever 93 which pivots about shaft 94 such that cam 95 is capable of selectively biting down upon the stretch cord to increase or decrease the length on segment 83B as compared to segments 83A and/or 83A′.

Reference is made to FIG. 6 illustrating a second embodiment of the present invention. Specifically, hub 60 is configured with receiving slots 71, 72, 73, 74, 75 and 76 and openings 21, 22, 23, 24, 25 and 26, the latter series of openings being provided for the optional attachment of bungee cords 43, 44 etc. by passing hooks 45 and 46 within disc 60 as a means of appending traditional bungee cords thereto. Any number of receiving slots and openings can be employed in practicing the present invention further noting that hub 60 can be composed of any rigid material such as metal or plastic which is chosen to resist breakage when employed for its intended purpose. Hub 60 is shown to be circular which is its preferred geometry although other geometric shapes can be employed without deviating from the spirit and scope of the present invention.

A plurality of stretch cords are applied to hub 60, each stretch cord being inserted through a pair of receiving slots diametrically opposed to one another. Specifically, a stretch cord having segment 61A travels through slots 71 and 74 being diametrically opposed to one another as shown; that portion of the stretch cord above hub 60 big identified as segment 61B and beneath hub 60 as segment 61A′. Similarly, stretch cord having segment 62A beneath hub 60 passes through slot 72 providing for segment 62B above hub 60 which then enters slot 75 extending beneath hub 60 as segment 62A′. Finally, bungee cords segment 63A passes through slot 73 whereby segment 63B resides atop hub 60 passing through diametrically opposed slot 76 creaing segment 63A′ beneath hub 60. In this embodiment, rather than employing clips 2 and 3 in order to adjust the terminal ends of one or more of the bungee cords as needed, the embodiment of FIG. 6 employees hooks 65 whereby terminal ends 66 pass there through for adjusting the length of the bungee cords and thus the distance between, for example, hooks 87 and 88.

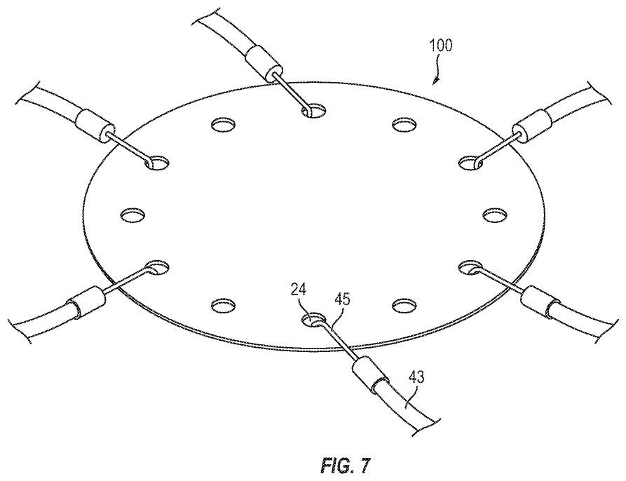

As a third embodiment, reference is made to FIG. 7. In this embodiment, hub 100 is configured with a series of openings 24 through which hooks 45 extend from traditional bungee cords 43. Although this embodiment lacks the adjustability feature of embodiments 1 and 2 illustrated in FIGS. 5 and 6, one can use bungee cords 43 of different lengths and achieve similar results. It is noted, however, that when working with embodiments 1 and 2, bungee cords of standard lengths can be employed which can be lengthened or shortened as needed on the job site, while embodiment 3 illustrates the recognition that hub 100 (as well as hubs 10 and 60) can be employed with standard bungee cords in providing a convenient attachment device which is lacking in bungee cord attachment protocols currently available.

It should be quite apparent that what is shown is a novel and unique tie down device which possesses numerous advantages over the use of typical bungee cords. Although the example used herein is for the tie down of the contents of an open bed vehicle, the present invention can be employed in any situation where bungee cords have been used. This device not only results in a superior means of storing bungee cords when not in use but also reduces the number of such cords which a typical user may otherwise require.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. A tie down device comprising:
a hub, said hub having a peripheral edge and plurality of stretch cord receiving slots; and
a plurality of stretch cords, each of said stretch cords being sized to pass within and be retained by a pair of receiving slots such that each stretch cord has terminal ends that extend on a first side of said hub and a looped body portion extending on a second side of said hub.

2. The tie down device of claim 1 wherein said hub is circular.

3. The tie down device of claim 1 wherein said receiving slots are configured within said hub in diametrically opposing pairs.

4. The tie down device of claim 3 wherein said securing slots are located proximate the peripheral edge of said hub.

5. The tie down device of claim 1 wherein passageways are configured within said hub between said receiving slots and hub peripheral edge to facilitate introduction to and removal of said stretch cords within said receiving slots.

6. The tie down device of claim 1 wherein hooks are retained at terminal ends of each of said stretch cords.

7. The tie down device of claim 1 wherein said hub further comprises bungee cord receiving openings spaced from said stretch cord receiving slots.

8. The tie down device of claim 1 further comprising a pair of clips positioned along at least one of said looped body portions to adjust the length of said at least one stretch cord terminal ends emanating from said hub.

9. The tie down device of claim 1 wherein the length of one or more of said plurality of stretch cords is adjustable.

10. A tie down device comprising:
a hub, said hub having a peripheral edge and a plurality of stretch cord receiving openings; and
a plurality of stretch cords, said stretch cords being terminated with hooks, said hooks being sized to pass within and be removably retained within said stretch cord receiving openings.
